(19) United States
(12) Patent Application Publication
(10) Pub. No.: US 2013/0226053 A1
(43) Pub. Date: Aug. 29, 2013

(54) Adjustable Postural Support Device

(71) Applicants: Mehnaz Khan, Santa Rosa, CA (US); Carolyn Bartlett, Santa Rosa, CA (US)

(72) Inventors: Mehnaz Khan, Santa Rosa, CA (US); Carolyn Bartlett, Santa Rosa, CA (US)

(21) Appl. No.: 13/385,583

(22) Filed: Feb. 27, 2012

(51) Int. Cl. A61H 7/00

(52) U.S. Cl. 601/134

(57) ABSTRACT

An improved postural support device having a plurality of supports that are designed to promote scapular retraction. The supports are adjustable and customizable in size and shape per a user's needs. A user can vary placement of the supports against the scapulae in order to achieve a desired level of retraction.

### CROSS-REFERENCE TO RELATED APPLICATIONS

This application claims the benefit and priority of PPA Ser. No. 61/464,121, filed 2011 Feb. 26 by the present inventors, which is incorporated by reference.

### BACKGROUND

The following is a tabulation of some prior art that presently appears relevant:

U.S. Patents and Publications

| Patent or Publication | | | |
|---|---|---|---|
| Number | Kind Code | Issue/Filing Date | Patentee |
| 7,413,250 | B2 | 2008 Aug. 19 | Connolly et al |
| 7,967,379 | B2 | 2011 Jun. 28 | Walters et al |
| 4,981,325 | | 1991 Jan. 01 | Zacharkow |
| US 2011/0031791 A1 | A1 | 2006 Mar. 29 | Newkirk et al |

Daily, necessary activities such as driving or working at a computer can cause or exacerbate an improper postural position. Presently available car seats, office chairs, and other forms of seating may sometimes have ergonomic design elements, but can continue to cause unnatural posture that leads to compression of the thoracic outlet and shoulder regions. As an example, bucket car seats may cause an unnatural slouching posture. A prolonged slouching position while seated (such as, but not limited to, when typing at a desk or driving for extended periods of time) changes the length and flexibility of the stabilizing muscles (e.g., rhomboids, latissimus dorsi, trapezius, etc), of the upper quadrant (i.e., neck, upper back, and shoulder region). This can cause weakness in the stabilizing muscles and unnecessary contraction in the non-stabilizing muscles (e.g., scalenes, pectoralis minor/major, subscapularis, etc) in order to continually maintain the unnatural posture. The result is abnormal shoulder curvature and other non-natural positions, nerve and vascular compression and muscle fatigue—ultimately manifested as pain, numbness, and tingling in the user's extremities.

Ergonomic office chairs are an example of a partial solution. Though they may support the lumbar region, they fail to provide the upper quadrant support needed to help prevent non-stabilizing muscles from contracting. Thus, in the case of working at a computer, the situation can be exacerbated by typing on a keyboard, causing increased worker fatigue. Lumbar supports for use in a vehicle also fail to provide upper quadrant support. In the case of driving, the situation is further exacerbated by gripping a steering wheel, causing further driver fatigue.

Previous support devices and/or cushions have limited the design to support lumbar or sacral regions only, and/or not provided enough adjustability or customization to remedy underlying cause of the situation. Previous devices and/or cushions that do offer support to the thoracic and/or cervical spine do so by placing a cushion or support between the scapulae along the thoracic spine or with supports that are positioned horizontally across sections of the back. When a user leans against them, these designs serve to force the spine or back to conform to the shape of the support. While some may be portable or modular in design, or supporting part or all of the spinal region, presently available seat/back rests/supports are still lacking the design and functionality needed to appropriately address the user's cause of distress. The designs of previously existing support devices need improvement in order to properly support the user.

There is therefore a need in the art for improved postural support device designs that support the shoulders in their naturally retracted position, thereby improving muscular stability, increasing circulation and decreasing pain and fatigue.

### BRIEF DESCRIPTION OF THE DRAWINGS

The following figures illustrate this embodiment.

FIG. 1 illustrates frame 10 and wedge-shaped cushion 12.

FIG. 2 illustrates frame cover 14.

FIG. 3 illustrates support members 16 and scapular supports 18. Note markers along support members 16 for identifying setting of optimal position.

FIG. 4 illustrates adjustable support members 16, frame 10, mounts 26 and 27.

FIG. 5 illustrates tension adjuster 20 and frame 10 with frame cover 14. Note markers for identifying setting of optimal position.

FIG. 6 illustrates scapular supports 18, support members 16, frame 10, mounts 26 and 27, which together illustrate an embodiment of a scapular support assembly.

FIG. 7 illustrates an entire apparatus and adjustable straps 32, excluding optional items, except optional wedge 12.

FIG. 8 illustrates a close-up of the connection 26 allowing rotation, translation and securement of the support members 16 to frame 10. The addition of markers allow for identifying and saving a setting of optimal position.

FIG. 9 illustrates a user 22 sitting in a chair 23 as known in the prior art. Such chair 23 lacks proper support. Note poor, unsupported posture in which the shoulders of user 22 are in an unnatural, protracted position. The natural curvature of the spine is lost, the scapulae 24 are not retracted, and muscles such as subscapularis and pectoralis minor must contract to maintain this position.

FIG. 10 illustrates an aerial view of unsupported user 22.

FIG. 11 illustrates user 22 sitting in a bucket seat 23 without proper support. Note the poor, unsupported posture in which the shoulders are in an unnatural, protracted position. The natural curvature of spine is lost, the scapulae 24 are not retracted, and muscles such as subscapularis and pectoralis minor must contract to maintain this position.

FIG. 12 illustrates user 22 sitting in chair 23 with an exemplary postural support device. Note the posture in which the thoracic/cervical regions return to a more neutral spine position, shoulder blades are lowered and retracted towards a neutral position, the natural curvature of spine is restored, and posture is significantly improved, resulting in improved scapular stability in the thoracic spine.

FIG. 13 illustrates an aerial view of supported user 22.

FIG. 14 illustrates user 22 sitting in bucket seat 23 with an exemplary postural support device. Note the posture in which thoracic/cervical regions return to a more neutral spine position, shoulder blades are lowered and retracted towards a neutral position, the natural curvature of the spine is restored, and posture is significantly improved, resulting in improved scapular stability in the thoracic spine.

FIG. 15 illustrates lumbar support 28.

FIG. 16 illustrates neck support 30.

FIG. 17 illustrates adjustable support members 16, scapular supports 18, frame 10, removable adjustable straps 32 and optional lumbar support 28.

FIG. 18 illustrates adjustable support members 16, scapular supports 18, frame 10, removable adjustable straps 32 and optional neck/cervical support 30.

FIG. 19 illustrates a detailed embodiment of the apparatus, including various optional items.

FIG. 20 illustrates the device comprising a seatback of an office chair bottom, 36. The device may be attached to the office chair using appropriate methods known in the art.

FIG. 21 illustrates one way a user 22 may place the scapular supports 18 along the medial edge of the scapulae 24 and on either side of the thoracic spine 37 in order to achieve scapular retraction. The acromioclavicular joint 39, which is the junction between the highest part of the scapula 24 and clavicle 40, is also illustrated.

FIG. 22 illustrates the customized fit process used to create a postural support device based on unique requirements and physical makeup of a user 22.

### DETAILED DESCRIPTION

These embodiments provide for a postural support device that is adjustable, modular, and portable. The device may be referred to interchangeably as “device”, “support device”, “postural support device” or “adjustable postural support device”. The adjustable, modular, and portable support device is designed to provide musculoskeletal support by minimizing instability of muscles and directly supporting the scapulae. Such instability may result in abnormal shoulder curvature and other non-natural positions when seated for extended periods of time. The support device, by virtue of its design, can provide relief for individuals suffering from many ailments, such as, but not limited to: thoracic outlet syndrome (TOS), carpal tunnel syndrome (CTS), hypermobility, repetitive stress injury (RSI), soft tissue inflammation, shoulder impingement, fibromyalgia, and myofascial pain syndrome.

The device due to its unique, customizable, adjustable and modular shape helps support the scapulae directly, resulting in a person's thoracic and cervical regions to become properly aligned in a neutral position. Muscles, such as subscapularis and pectoralis major/minor, that were previously contracted causing scapular instability, are relieved from overwork when the scapulae are retracted towards neutral position. Thus, an improvement to spinal and scapular support is achieved.

The device in a first embodiment is designed to be portable, such that it can be used in seating found in cars, planes or other forms of transport, as well as in chairs in the home, office, or other places where one needs to sit. Removable straps and a high friction backing ensure that it can be secured for use in a variety of environments without slippage.

The device is also designed to be adjustable and modular, to enable the support provided to the user to be customized in a variety of ways. For example, a user undergoing physical therapy for the abovementioned ailments may wish to make adjustments to the amount and location of support as his or her muscles progressively improve their stability and alignment from treatment. In another example, a user with asymmetrical winged scapula may desire additional support on one side and less support on his or her other side. A process as detailed in this application may be applied for each individual user to obtain a customized fit.

Therefore, in comparison to other designs known in the art, various aspects of the adjustable, modular support device may have one or more of the following advantages: to provide adjustable and customizable support to the user's upper quadrant, to allow the user's spine to take its naturally curved shape, to address multiple causes of poor posture, to be portable, to be usable in multiple seating arrangements (e.g., car, office, plane, etc.), to have a lightweight and sturdy design, to be adjusted by the user with ease, to be easily manufactured, to have a shape and design that does not restrict movement, to have a design that minimizes contact with the user's body, to have indications (including but not limited to markings) that allow user to “save” a desired configuration, to provide adjustable support that is customizable in a multitude of ways, including but not limited to: cross section, cross section shape, foam stiffness, height, length, separation, and curvature. Other advantages of one or more aspects will be apparent from a consideration of the drawings and ensuing description.

The adjustable supportive parts are joined via an attachment mechanism which provides infinite adjustability among these parts allowing a user to easily change and customize the configuration of the cushions and supports. An individual's complete device can consist of any combination of adjustable supportive parts.

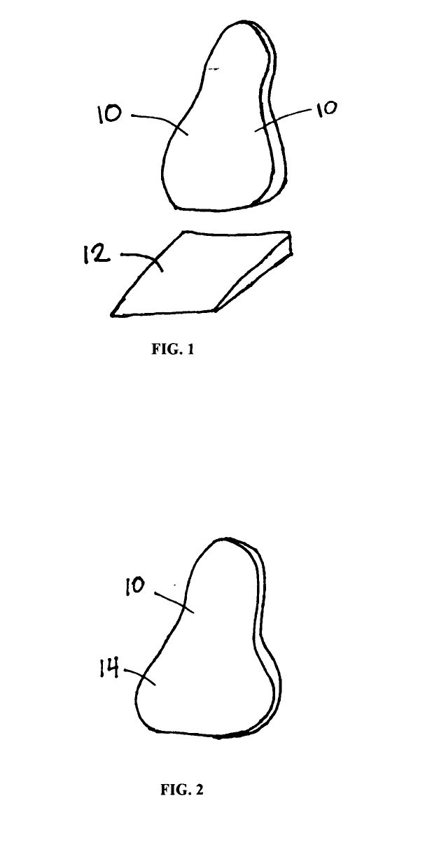

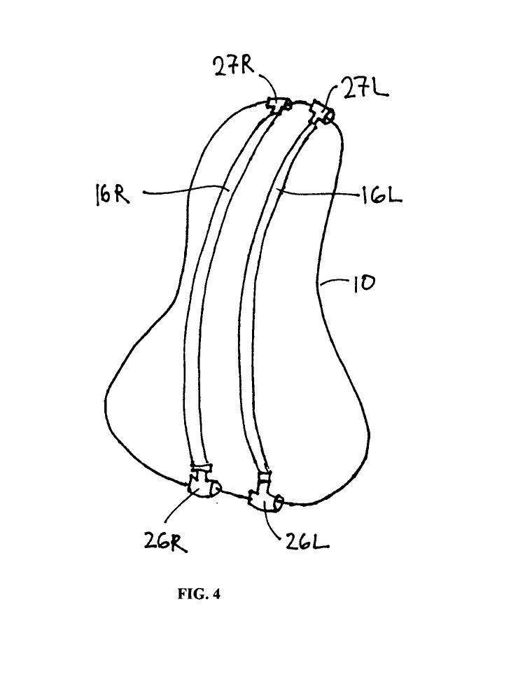

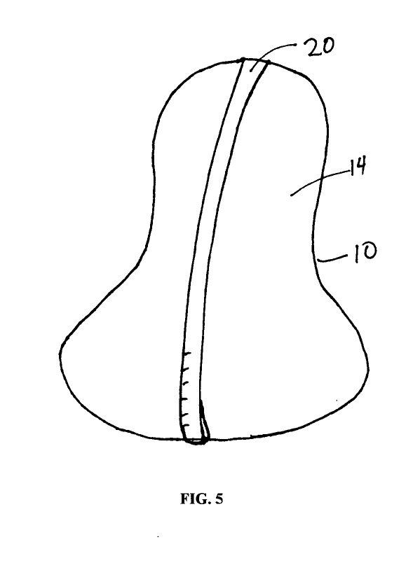

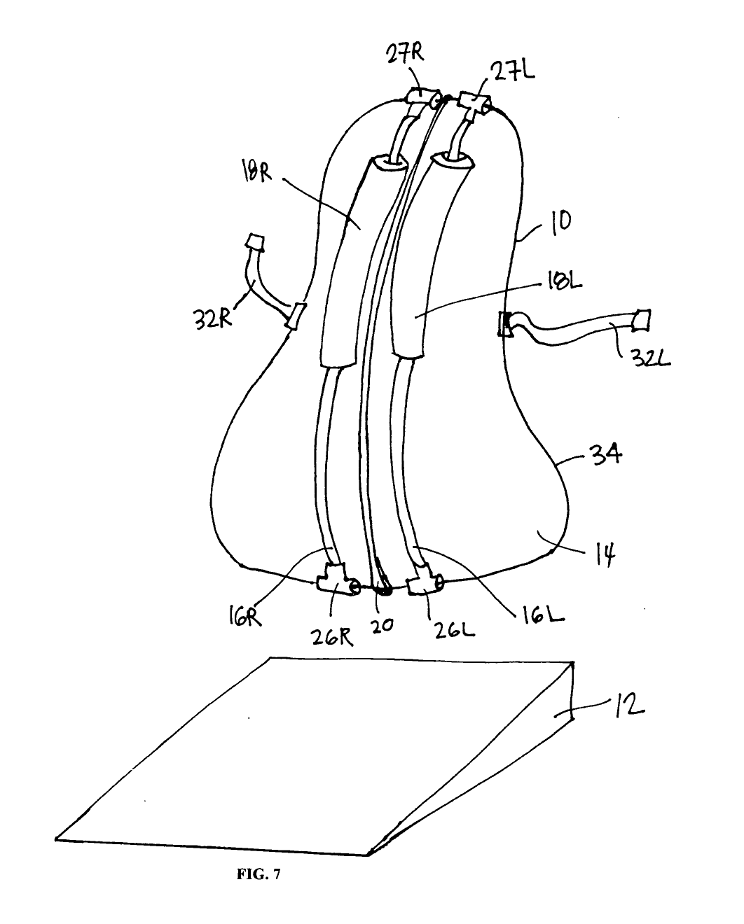

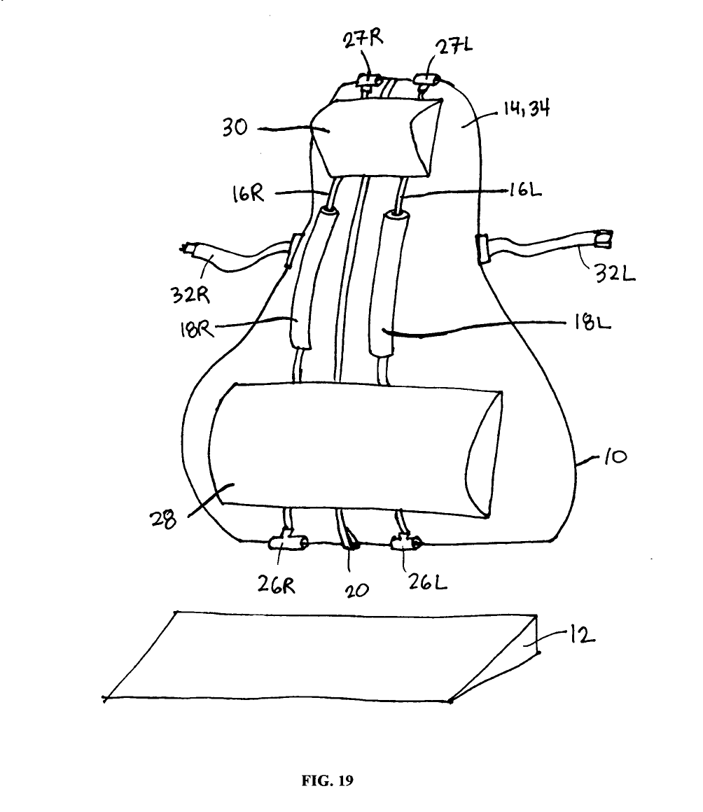

FIG. 1 illustrates frame 10 and cushion 12. Frame 10 is configured for use with various types of seats (e.g., chairs, car seats). In an exemplary implementation, frame 10 is placed against the back of a chair, such that when the user is seated in the chair, frame 10 is located between the chair and the user's back. Frame 10 provides support for the adjustable and configurable components (shown in FIG. 4, FIG. 7, and FIG. 19) which function to provide scapular stability to the user. Frame 10 may be made of metals, plastics or any other appropriate material known in the art.

FIG. 1 further illustrates an implementation with a cushion 12 in a wedge shape. Cushion 12 is optional to the primary support device. In an exemplary implementation, cushion 12 rests on top of the chair seat, and a user sits on top of cushion 12. Cushion 12 may be adjustable in several dimensions, including height and angle of inclination. Such adjustments may be performed according to methods known in the art. Cushion 12 may be made of foam or other appropriate supportive materials.

FIG. 2 illustrates an optional frame cover 14 fitted over frame 10. While frame 10 provides (most of) the structure, frame cover 14 provides a removable barrier between the frame 10 and the user. Frame cover 14 may further provide additional support, assist in comfort, resist dirt/staining, etc. Frame cover 14 may be made of flexible fabric materials and be fitted over the frame and removed according to methods known in the art.

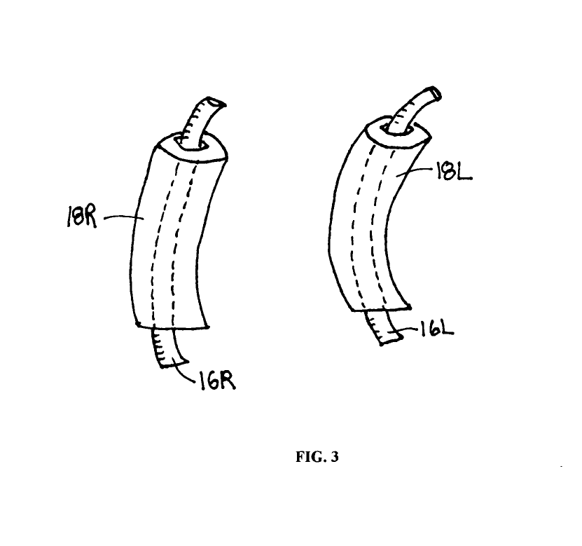

FIG. 3 illustrates an implementation of scapular supports 18 and support members 16 for left and right sides. Scapular supports 18 may be configurable for each side per the user's needs in the following attributes: in diameter, length, height, cross-sectional shape, cross-sectional area, stiffness, centerline-to-centerline distance apart, curvature. Scapular supports 18 may have a hollowed core that allows an interference fit with the support members 16 so that the position of the scapular supports 18 may be adjusted along the length of the support members 16. A cylindrical shape may be used because, by virtue of its circular cross-section, contact with the user's body along the cylinder length will be minimized. Many sufferers of neuropathic pain experience a heightened sensitivity to touch and this design helps minimizes contact with the user.

The user slides the scapular supports 18 along the support members 16 to the desired location so that when the user is seated in a chair such that the support device is placed between the user's back and the chair, the scapular supports 18 may make contact with the user's scapulae so that proper scapular stability may be achieved by allowing the scapulae to adduct from the pressure applied by the user leaning against the scapular supports. The support members 16 may have designations so the user may clearly “save” the setting of the scapular supports 18 most ideal to him/her. The support members 16 may be made out of plastic, composite, or any lightweight material capable of bearing the load of the user when the user is seated against them. The scapular supports' 18 may be variable, and may be modified depending on user preferences, for example, but not limited to: foam, memory foam over a rigid core; gel pack over a rigid core, or just the rigid core. Other shapes that are effective in providing support may be used.

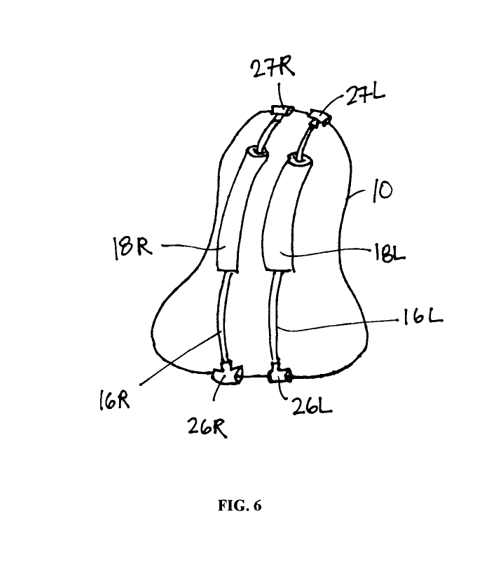

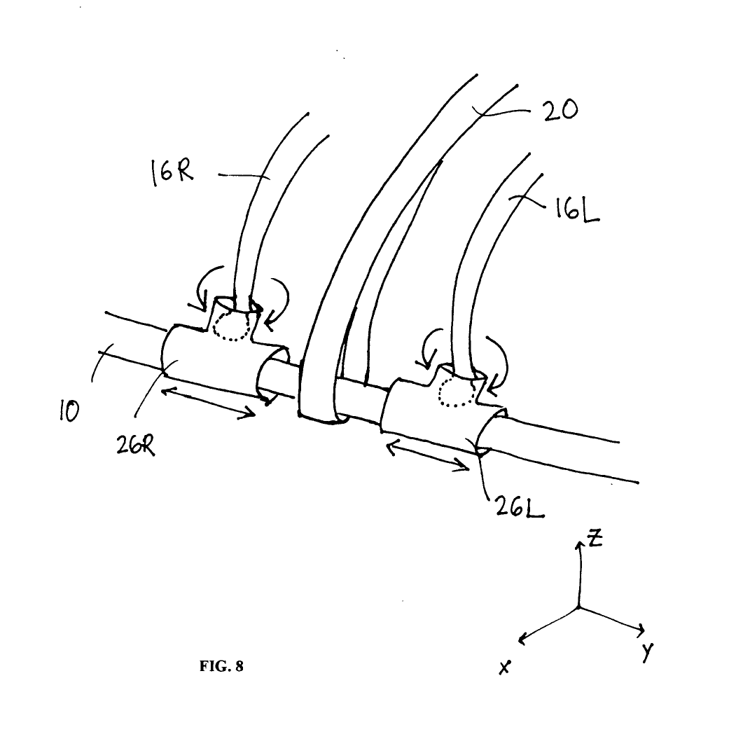

FIG. 6 and FIG. 8 illustrate an implementation of the support members 16 attached to frame 10 via the attachment mechanisms 26 and 27. The optional cushion 12 is also illustrated. The attachment mechanisms 26 and 27 may allow the support members 16 to be adjustable in the following ways: by allowing the support members 16 to pivot about the Z-axis in the X-Y plane and to translate along the Y-axis of the frame 10, as illustrated in FIG. 8. The attachment mechanisms 26 and 27 may have designations so the user may clearly “save”, and lock into place using methods known in the art, a setting of the support members 16 most ideal to user 22. This could be, but not limited to, markings, or indentations making a “clicking” noise.

FIG. 5 illustrates the tension adjuster 20 and how it attaches to frame 10. The tension adjuster is secured to the top of frame 10 and wraps around the bottom of frame 10 such that when it is pulled up from the bottom and secured to itself, the frame 10 bows slightly, allowing the user to increase the profile and adjust the curvature of the scapular supports 18. The tension adjuster 20 may be made out of durable cloth or other suitable materials and the attachment mechanism may be made of a hook-and-loop fastener or other suitable materials.

FIG. 6 illustrates support members 16 and attachment mechanisms 26 and 27. The support members connect to frame 10 via attachment mechanisms 26 and 27. Any suitable connection for allowing support members 10 to attach to the frame 10 may be used as a attachment mechanism. An optional wedge 12 is also illustrated.

FIG. 7 illustrates an implementation of the postural support device. The user places the postural support device against the back of a chair and the cushion 12 on top of a chair seat. The user slides each support member 16 to the desired location such that the left and right scapular supports 18 will contact the user's left and right scapula, respectively. The user may also adjust the rotation of each support member 16 if further adjustment is desired. The user may lock the support members 16 into place. The user slides the scapular supports 18 along the support members 16 until the desired location is achieved, such that sufficient scapular stability is obtained. The user may secure the postural support device to the back of a chair using the straps 32. The straps may be made of cloth and may be attached to the frame cover 14 or directly to the frame 10. The straps secure to one another using methods known in the art.

FIG. 8 illustrates a close-up of how the support members 16 may be mounted to the frame 10 via mounts 26. The various adjustments are indicated by the directional arrows. The support members 16 may rotate and translate by way of any suitable mechanisms known in the art. A similar set-up may be used for the top mounts 27 as well.

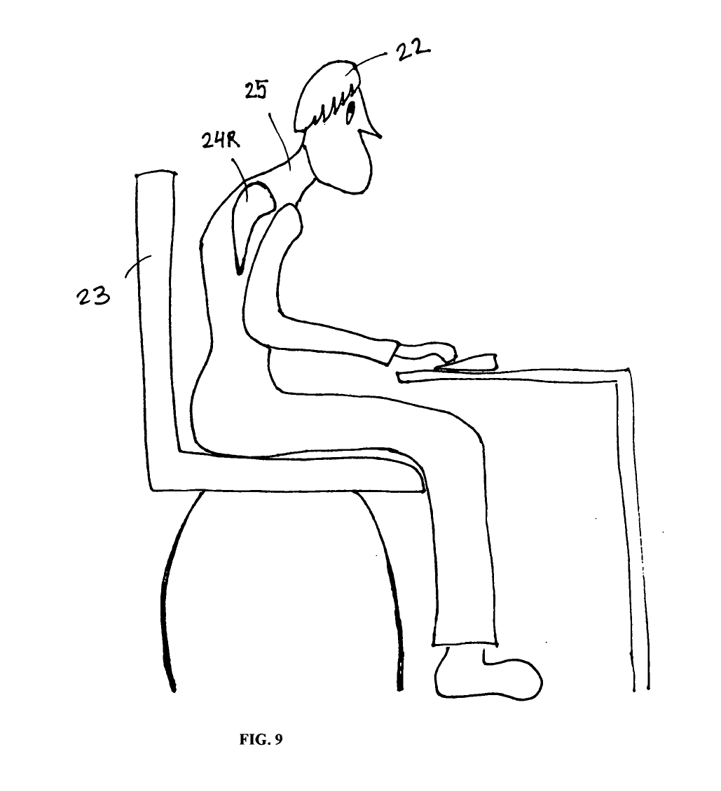

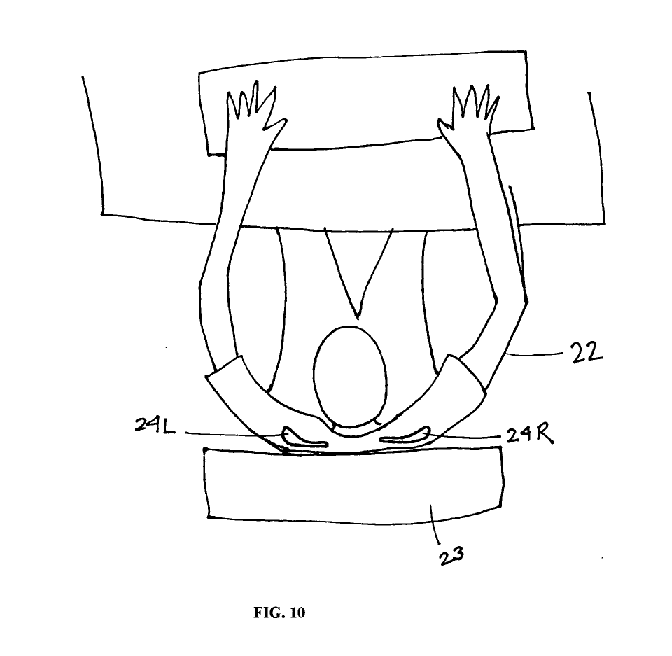

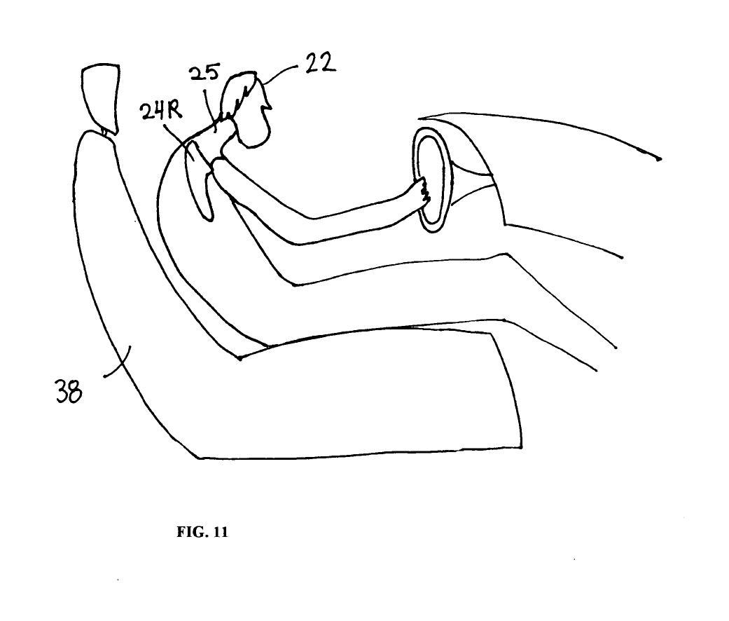

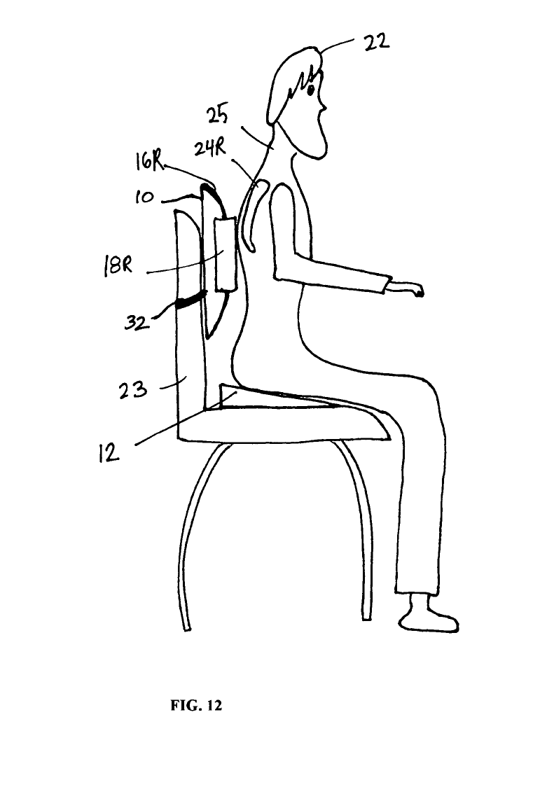

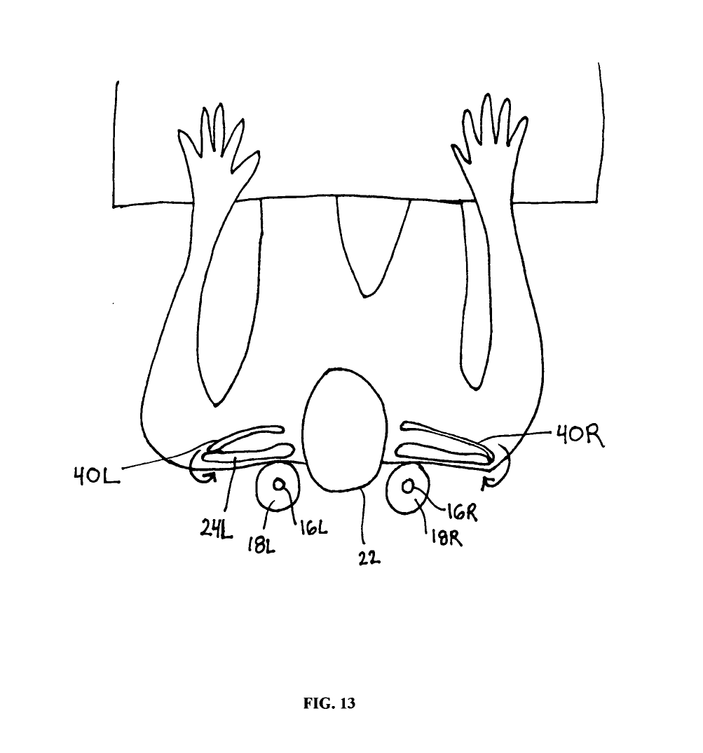

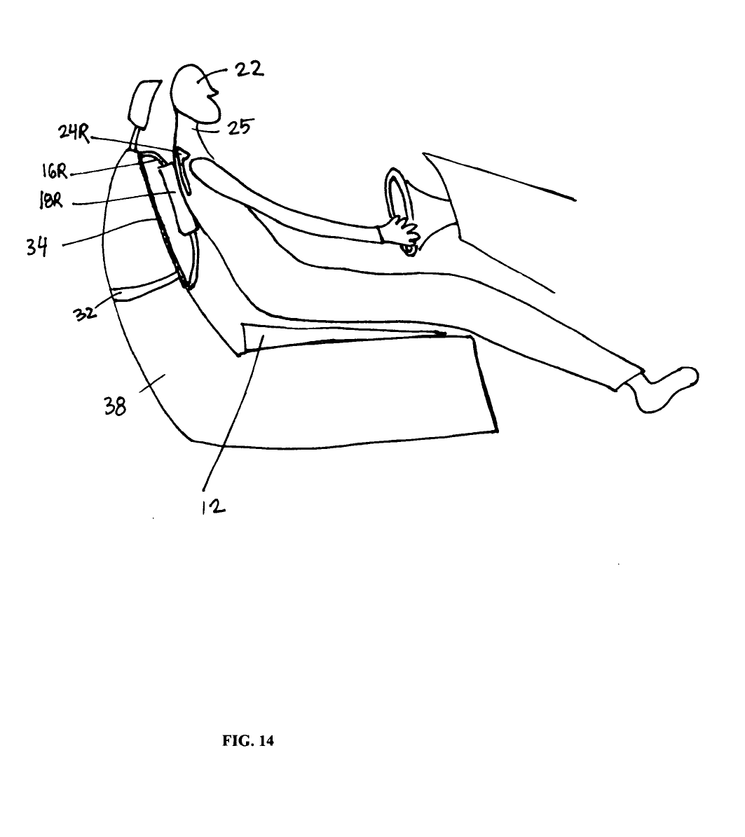

FIG. 9 illustrates a user 22 sitting on an office chair 23. Note position of scapula 24 and neck 26 for comparison of FIGS. 9, 10 with FIGS. 12, 13; and FIG. 11 compared with FIG. 14. Notice acute angle of hip and legs, which contributes to slouching posture and may be mitigated by using optional wedge 12.

FIG. 10 illustrates an aerial view of the user 22 sitting on a chair 23. Note protracted position of scapula 24 for comparison of FIGS. 9, 10 with FIGS. 12, 13; and FIG. 11 compared with FIG. 14.

FIG. 11 illustrates a user 22 sitting in a car seat 38. Note position of scapula 24 and neck 26 for comparison of FIGS. 9, 10 with FIGS. 12, 13; and FIG. 11 compared with FIG. 14. Notice acute angle of hip and legs.

FIG. 12 illustrates an interaction of the user 22 with the postural support device used in a chair. Notice the shoulders are lowered, scapulae are retracted towards a neutral position, and the natural curvature of the spine is restored. Overworked muscles are no longer contracting to maintain a slouching position, allowing proper stability when the user performs tasks while seated. The angle of the hip and legs is also increased, which helps to improve posture.

FIG. 13 illustrates an aerial view of the user 22 with the postural support device. Notice the user's head is positioned over his spine, i.e., the user is no longer slouching, and the shoulders are lowered with the scapula retracted.

FIG. 14 illustrates an interaction of the user 22 with the postural support device used in a car seat. Notice the shoulders are lowered, scapulae are retracted towards a neutral position and the natural curvature of the spine is restored. Overworked muscles are no longer contracting to maintain a slouching position, allowing proper stability when the user grips the steering wheel. The angle of the hip and legs is increased, which helps to improve posture. An optional high-friction backing 34 prevents slippage of the postural support device. The high friction backing 34 may be made of flexible fabric materials that provide sufficient friction to prevent slippage.

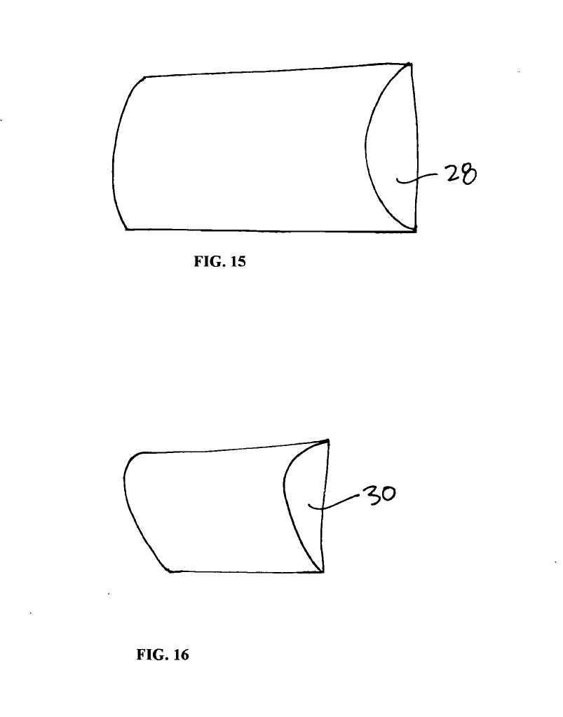

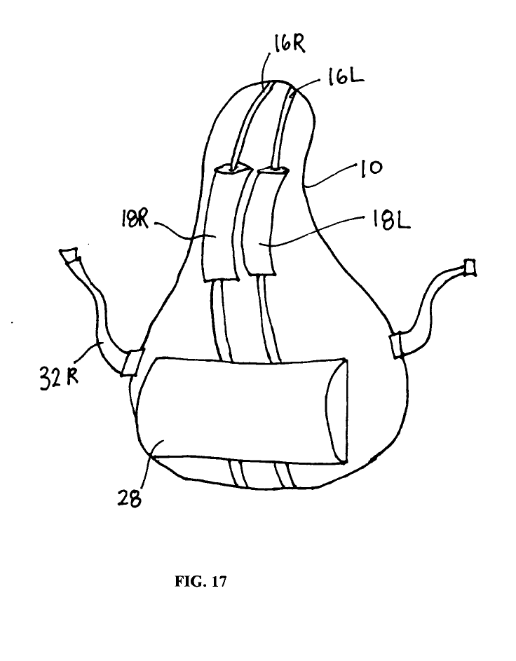

FIG. 17 illustrates an implementation of an optional lumbar support cushion 28 in a half-cylinder shape (shown in detail in FIG. 15). The lumbar support cushion 28 may, however, appear in alternate shapes, and has adjustable dimensions: length, diameter (height), profile (radius), and may be attached to the support members 16. Such adjustments and attachments may be performed according to methods known in the art. Cushion 28 may be made of foam or other appropriate supportive materials.

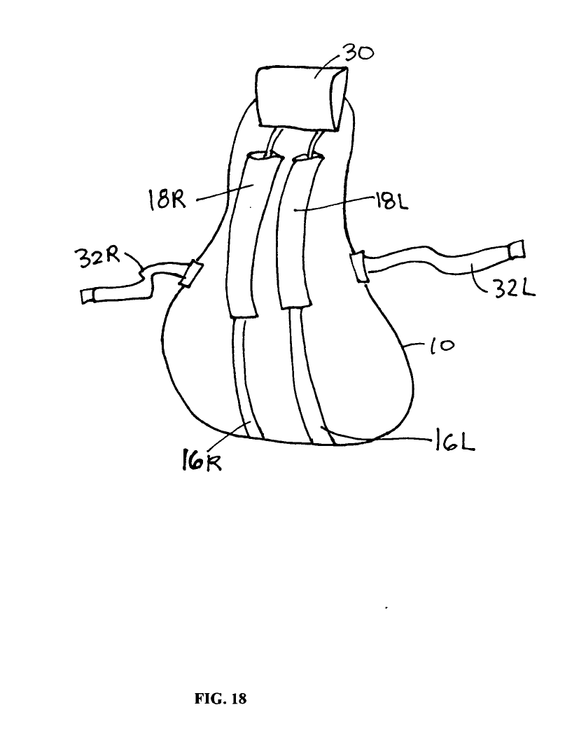

FIG. 18 illustrates an implementation of an optional neck/cervical support cushion 30 in an off-center cylindrical shape (shown in detail in FIG. 16). The neck/cervical support cushion 30 may, however, appear in alternate shapes, and has adjustable dimensions: length, diameter (height), profile (radius), and may be attached to the support members 16. Such adjustments and attachments may be performed according to methods known in the art. Cushion 30 may be made of foam or other appropriate supportive materials.

FIG. 19 illustrates an embodiment of the entire apparatus, including all optional components. A frame 10 may provide the support structure for support members 16, which may be affixed to the frame 10 via mounts 26. Such mounts 26 may allow rotational and translational movement to adjust the separation and angle of the support members 16. Mounts 27 along top of frame 10 may allow rotation and translation of support members 16. Mounts 26 and/or 27 can be secured once a desired position is obtained. A tensioner 20 may allow adjustment of the profile (curvature) of scapular supports 18 and the support members 16. An optional wedge 12 may provide additional postural support. The scapular supports 18 can slide on the support members 16 to adjust their height. Additional features may include a high-friction backing 34 to minimize slippage of the thoracic/cervical support device, optional lumbar support 28, and optional neck support 30. Lumbar support 28 and neck support 30 may be adjustable and attachable to the support members 16. Removable straps 32 allow the apparatus to be secured to a wide range of seating options (for example, but not limited to, an office chair or car seat).

The user may place the wedge, if desired, on the seat. The user may then place the postural support against the seat back. User may adjust the separation distance and angle of the support members, the location of the scapular supports along the support members, the profile (via the tension adjustment 20), and secure the adjustments via the attachment mechanism of mounts 26 in place. The user may attach lumbar support and neck support, if desired, to the support members.

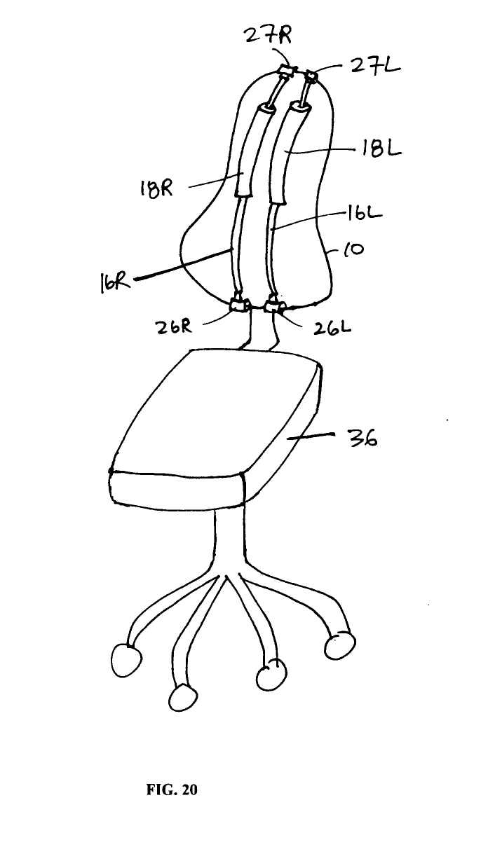

In some embodiments, the frame of the postural support device can be made out of any material that will provide sufficient support for components while still being easy to manufacture into the desired shape. In some embodiments, frame 10 may have an inverted-bulb like shape, with a wider base and narrower top, which may allow a user's arms to move freely on either side without obstruction while still providing adequate support for the cushion components. Support members 16 may be made out of cloth or other such material if the frame 10 is designed to directly bear load of the user 22 applied to the scapular supports 16. Any type of mechanisms known in the art can be used to connect the various parts to the frame or to each other. An embodiment may be made with adjustability for only some attributes (for example, but not limited to: allowing or not allowing rotation of support members; allowing or not allowing adjustment of curvature of support members, etc). In some embodiments, the cover material may not be meshed. In some embodiments, the frame 10 can be designed to make it free-standing, so that if a seat has no back rest, the user's weight can provide the necessary support required to create a backrest. In some embodiments, the device may itself comprise a permanent seat back of a chair or other seating apparatus such that it is not portable, as illustrated in FIG. 20.

Whereas in the previous embodiment, the support structures were referred to as “support members 16” and “scapular supports 18”, in other embodiments, the supports may take other shapes (such as, but not limited to, oval, rectangular, elliptical, spherical, etc.). The support members 16 and scapular supports 18 may be designed as a single piece. The supports may be made out of any suitable material or materials capable of providing support to the user. In some embodiments, any design that allows the user 22 to adjust the curvature of the supports can be used to address this functionality, thereby eliminating the need for a tension adjuster 20. A design allowing independent adjustment of the curvature for each support may be used. The frame may be designed in any way that allows supports to be mounted and maintain their adjustability, such as but not limited to a “Y-like” shape where each “Y” arm extends toward a scapula or with a solid-backing surface to which the supports 18 may mount directly, which may eliminate the need for support members 16 altogether.

Optionally, additional supports can be added, such as for the lumbar and cervical regions. In various embodiments, these supports may be independently adjustable and may attach directly to the frame 10 or to support members 16. Multiple lumbar and cervical supports are also possible to better support the user. Any other design that allows adjustability can be implemented. Any other design that supports the thoracic/cervical regions and/or scapulae as described by these embodiments or otherwise may be used. Support members 16 may consist of any design that allows support of scapular supports 18. Scapular supports 18 may consist of any design that allows adjustability to suit user's needs. Material of the scapular supports 18 can be vary, and may change depending on user preferences, for example, but not limited to: foam, memory foam over a rigid core; gel pack over a rigid core, or just the rigid core. Other shapes that are effective in providing support may be used.

From the description above, a number of advantages of some embodiments of our postural support device become evident:

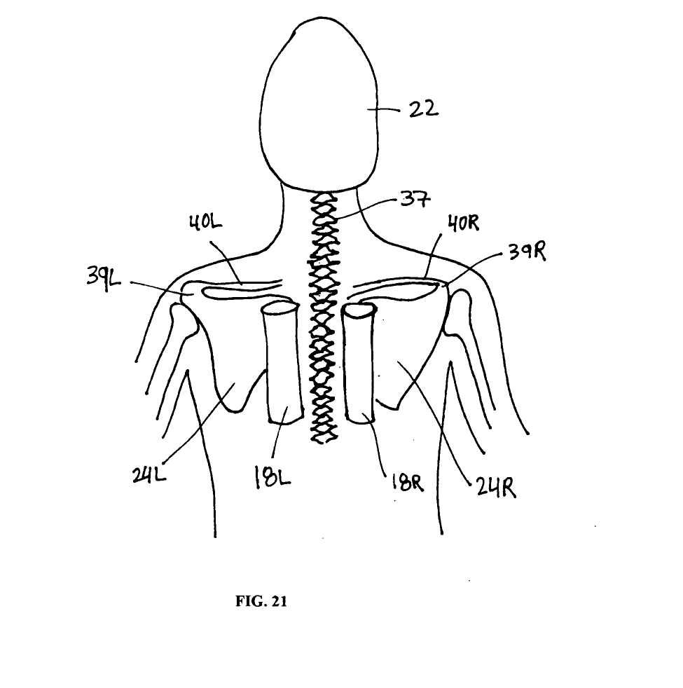

Two, independently adjustable supports (referred to as “support members 16” and “scapular supports 18” in previously described embodiments) allow the user to position each support as he/she desires; for example, one on either side of the thoracic spine or along the medial edge of either scapula as show in FIG. 21. Two supports also allow for greater customization and adjustability to serve the user's needs because, for example, they may be placed independently of each other with different sized supports for either side.

The vertical orientation and oblong shape of the scapular supports 18 promote retraction of the scapulae when placed along medial edge of either scapula, as shown in FIG. 21. Previously designed support devices apply direct pressure to the thoracic spine or inter-scapular region which attempts to achieve scapular retraction by straightening the thoracic spine, but may continue to cause discomfort to the user due to inadequate support to the scapulae and lack of support to surrounding muscles. Other supports use cushions in shapes that conform to the existing curvature of the back, such as a crescent shape. Rather, the design described in these embodiments emphasizes retraction of the scapulae by using the scapular supports 18 to transmit a force to the scapulae which causes the scapulae to pivot about the acromioclavicular joints 39. If each scapula is likened to a lever with a force, represented by the pressure from the user 22 leaning against the scapular supports 18, that is applied opposite the fulcrum, represented by the scapula's point of attachment to the clavicle 40, the acromioclavicular joint 39, then one can see how the scapulae retract when supports are correctly placed, as shown in FIGS. 13 and 21. Arrows in FIG. 13 represent direction of rotation of each scapula. Properly retracted scapulae promote a neutral thoracic spine and aid other muscles of the upper quadrant, such as scalenes and pectoralis minor, to relax and return to their neutral positions. This design also minimizes contact with the user, allowing for greater freedom of movement.

Customization is available in many ways such as but not limited to cross section, cross section shape, height, support material, length, etc. Some users may have muscular or other imbalances that could require different levels of support on each side. The user may find the benefits of one support placed along the length of each scapula rather than a single support placed between the scapulae or along the spine provides greater relief of symptoms.

Customization is aided by a customized fit process using user feedback to obtain optimal settings.

Lightweight materials aid in portability and ease of use for the user. Many users suffering from any of the conditions previously stated have limited dexterity, range of motion, and difficulty carrying objects.

The ability of the support device to maintain a desired configuration ensures the user can return to the seat without having to make readjustments.

While various embodiments have been described above, it should be understood that they have been presented by way of example only, and not limitation. The descriptions are not intended to limit the scope of the embodiments to the particular forms set forth herein. To the contrary, the present descriptions are intended to cover such alternatives, modifications, and equivalents as may be included within the spirit and scope of the embodiment as defined by the appended claims and otherwise appreciated by one of ordinary skill in the art. Thus, the breadth and scope of a preferred embodiment should not be limited by any of the above-described exemplary embodiments.

Thus the scope of the embodiments should be determined by the appended claims and their legal equivalents, rather than by the examples given.

### Postural Support Device Customized Fit Process

The customized fit process for the postural support device may be designed to ensure that each user of the device receives an optimal fit, specific to his or her body.

The ability of the device to alleviate activity in non-supporting muscles can be measured using biofeedback and pain scales. Biofeedback is a technique by which a patient is able to recognize and eventually control involuntary processes by monitoring activity in real-time from electrodes attached to specific parts of the body. Biofeedback may also be used without electronics. For example, the user may become aware the muscles contracted if he or she is unable to breathe deeply and freely while using the device. This may be an indication that proper muscular and scapular stability has not yet been achieved. The user may also refer to a pain scale for feedback. The pain scale is a rating system used to subjectively measure a patient's level of pain. Together, these methods can be used to determine if the device is having its desired effect by rating the user's symptomatology before and after using the device. Multiple sessions over time may be required in order to train the user in identifying correct from incorrect muscle use. Alternatively, if electronic biofeedback is not available to the user, the user can rely on deep breathing and pain scales to assess the device's effectiveness.

Customizable parameters for the postural support device include, but are not limited to: support members 16: cross-sectional shape, profile, length, stiffness, centerline-to-centerline distance, stiffness, material; scapular supports: cross-sectional shape, length, diameter, profile, material, material density, stiffness, position, angle, centerline-to-centerline distance; neck/cervical and lumbar supports: cross-sectional shape, length, diameter, profile, material, material density, stiffness, position.

Step 1: Determine baseline parameters, such as but not limited to diameter, length, profile, etc.

Step 2: Select supports of desired material properties (material, stiffness, etc.) and dimensions taken from Step 1 and install complete device based on initial dimensions.

Step 3: Sit in chair without device and evaluate symptoms using pain scale and muscle activity using biofeedback and deep breathing.

Step 4: Sit in chair with device and evaluate symptoms using pain scale and muscle activity using biofeedback and deep breathing

Step 5: Assess response: If a positive response is felt (i.e., “no worse than with device”, or “better than without device”), increase time spent in chair with device and activity level (for example, use of computer or driving). A positive response may mean the user is able to breathe deeply and freely, sit without increase in symptoms, or have lessened muscle activity. Continue monitoring until user is able to complete a task (for example, drive to work, or type an email) without increasing symptomatology.

Step 6: Assess response: If a negative response (i.e., an increase in muscle activity, pain, or general feeling of “worse than before” or “worse than without device”) then the user 22 should be refitted and assessed again. The user 22 may be refitted in a number of ways, including but not limited to: adjusting the dimensions of the supports 18 to provide more or less scapular support; adjusting the location of the supports 18 either medially or laterally; adjusting the level of cervical and/or lumbar support, etc.

Step 7: Continue process until user is able to complete daily tasks with less or no negative response.

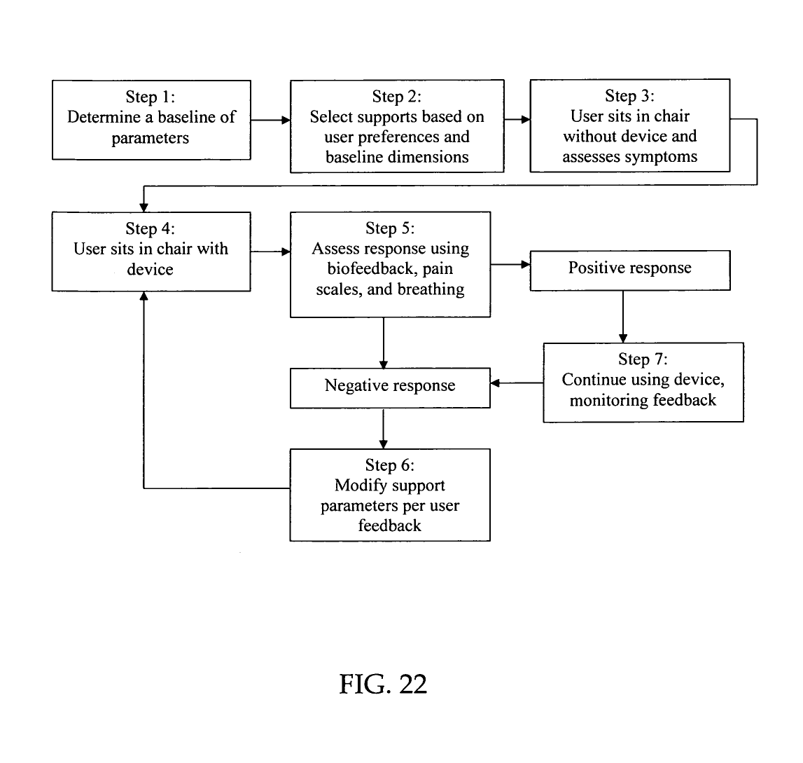

Refer to accompanying flow-chart to visualize process, shown in FIG. 22.

FIG. 22 illustrates the customized fit process used to create a postural support device based on unique requirements and physical makeup of a user 22.

Although the description above contains many specificities, these should not be construed as limiting the scope of the embodiments but as merely providing illustrations of some of several embodiments. Thus the scope of the embodiments should be determined by the appended claims and their legal equivalents, rather than by the examples given.

We claim:

1. A method for promoting scapular retraction in a person in a seated or reclining position, comprising:
i. seating a user on a seat portion of a seating device, said seating device comprising a scapular support assembly that is positioned and aligned to allow contact to one or more scapula or other location as desired by said person;
ii. resting said user's back against said scapular support assembly,
whereby resulting pressure promotes retraction of said person's scapulae via pivoting of said scapulae about said scapular support assembly.
a. The method of claim 1, wherein said seating device is a seating apparatus and said support assembly comprises all or part of a back of said seating device.
b. The method of claim 1, wherein said seating apparatus comprises any form of seating.
c. The method of claim 1 where said support assembly is portable.
d. The method of claim 1, wherein said scapular support assembly includes lumbar and cervical supports.

2. A postural support device, comprising:
i. a plurality of supports,
ii. a plurality of adjustment mechanisms allowing customized configuration of said supports,
iii. a modularity to said supports which allows for customization of attributes of said supports,
iv. a framework,
v. and a plurality of attachment mechanisms to allow said supports to connect to said framework.
wherein said supports of claim 2 further includes a scapular support assembly
e. wherein said device of claim 2 further includes a plurality of scapular supports
f. wherein said device of claim 2 further including support members to uphold said supports
g. wherein said supports of claim 2 are adjustable independently of one another via said adjustment mechanisms
h. wherein said supports of claim 2 are adjustable in horizontal, and vertical, and rotational placement
i. wherein said framework of claim 2 upholds said supports and said adjustment mechanisms via attachment mechanisms
j. wherein said supports of claim 2 are connected to said framework
k. wherein said supports of claim 2 are integrated with said framework
l. wherein said device of claim 2 is portable and attachable to a variety of seat backs.
m. wherein said device of claim 2 comprises a fixed, permanent seat back
n. wherein said device of claim 2 further includes lumbar and cervical supports
o. wherein said device of claim 2 further includes adjustment mechanisms for lumbar and cervical supports
p. wherein said supports of claim 2 are made of appropriately supportive material.

3. A method of identifying optimal parameters for a postural support device, comprising:
q. obtaining baseline measurements to characterize initial settings
r. using biofeedback to assess level of muscular activity obtained by said postural device parameters
s. using pain scales to assess level of muscular activity obtained by said postural device parameters
t. varying parameters until desired comfort level is obtained
